(19) United States
(12) Patent Application Publication
(10) Pub. No.: US 2013/0179863 A1
(43) Pub. Date: Jul. 11, 2013

(54) BUG VARIANT DETECTION USING PROGRAM ANALYSIS AND PATTERN IDENTIFICATION

(71) Applicants: Vipindeep Vangala, Hyderabad (IN); Sandeep Patnaik, Hyderabad (IN)

(72) Inventors: Vipindeep Vangala, Hyderabad (IN); Sandeep Patnaik, Hyderabad (IN)

(73) Assignee: Microsoft Corporation, Redmond, WA (US)

(21) Appl. No.: 13/347,713

(22) Filed: Jan. 11, 2012

(51) Int. Cl. G06F 9/44

(52) U.S. Cl. 717/124

(57) ABSTRACT

In one embodiment, a bug detection system may automatically identify bugs and bug variants in a source code set. The bug detection system 200 may identify automatically a template bug in a source code set 210. The bug detection system 200 may represent automatically the template bug as a bug pattern. The bug detection system 200 may identify a matching bug in the source code set 210 using the bug pattern.

### BACKGROUND

A software application may be created by a programmer drafting a source code set that is then compiled by a compiler into an executable binary data set. A software application may function improperly due to software errors, referred to as bugs. Bugs may be caused by typos in the source code set, improper integration of software objects, or other causes. A source code set may have thousands, or even millions, of code lines, any one of which may have one or more mistakes. Debugging, or correcting software errors, may involve going through the source code set line by line.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to automatically identifying bugs and bug variants in a source code set. The bug detection system may identify automatically a template bug in a source code set. The bug detection system may represent automatically the template bug as a bug pattern. The bug detection system may identify a matching bug in the source code set using the bug pattern.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a computing device.

FIG. 2 illustrates, in a block diagram, one embodiment of a bug detection system.

FIG. 3 illustrates, in a block diagram, one embodiment of a slicer.

FIG. 4 illustrates, in a block diagram, one embodiment of a source code set.

FIG. 5 illustrates, in a flowchart, one embodiment of a method for detecting a template bug.

FIG. 6 illustrates, in a flowchart, one embodiment of a method for detecting a matching bug.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a bug detection system.

Detecting a bug in a software program may involve finding places in a source code set having multiple variations of the same bug. Searching for bugs manually may be time consuming and inefficient. Missing a bug may be costly and lead to critical security vulnerabilities. Even if a fix for the bug is available, along with a root cause for the bug, detecting similar vulnerabilities by manual source code scan may be difficult and error prone. Moreover, searching for the fixed lines of code may not be fool proof. If a pattern may be identified from a given bug or fix, a bug detection system may search for similar patterns in the code in an automated way. A bug pattern, rather than describing the exact composition of the bug, describes a semantic relationship between variables in a bug. The bug detection system may use a program slicing mechanism along with change analysis to identify the pattern of a bug or an associated fix. The bug detection system may transform the bug pattern to be used by a detection engine using clone code search, model checking, or other techniques.

A slicing mechanism may reduce a source code set to a subset that influences or is influenced by a set of slicing criterion. The slicing criterion is a statement and a set of variables in the statement. A code slice may reduce a source code set to a minimal snippet representing a usage pattern of one or more target variables, increasing the similarity of true positives. The code slice may be computed using a data flow graph or a control flow graph. The code slice may be listed in code order or in temporal order to find a temporal pattern. A code order slice lists code lines in the order a code line appears in a listing of the code. A temporal order slice lists code lines in the order a code line is executed during runtime.

The bug detection system may identify the lines of code that cause a bug. The bug detection system may execute a change analysis, automatically identifying the lines of code that were changed from two versions of a binary data set and a source code set. A user may also specify the impacted lines of code and variables. The bug detection system may use a level number in a slicing criterion to identify a backward code slice and a forward code slice. The level number describes the number of predecessor lines or successor lines in the code slice. The level number may be inter procedural or intra procedural. The backward code slice may show how the bug propagated from the root cause. The forward code slice may show how the bug manifested. The output of the code slice may be a set of paths showing patterns of the bug.

The bug detection system may then convert a bug pattern into a format that may be easily detected by automated methods. The bug pattern may be converted into temporal logic rules that may be fed into model checking engine. The bug detection system may then map the extracted paths to the source code set and pass the result to a code clone detection engine. The bug detection system may then identify variants of a bug given a bug fix for the bug or symptoms of the bug.

The bug detection system may select a branch of the source code set, a file path, and a binary data set representing the executable of the source code set. The bug detection system may then identify a function that might be the source of the bug. The bug detection system may choose the start code line for the code slice, specifying whether the code slice is a forward code slice, a backward code slice, or a combination code slice. The bug detection system may set a level number for the code slice that is optimized to best produce a workable bug pattern from the code slice. The level number may be optimized based on telemetry reports from previous sessions of the bug detection system.

An example function in a source code set may be used to illustrate the slicing process.

| Char Foo( ) | |
|---|---|
| { | |
| 1 | Int myOffSet = getOffSet(GlobalParam); |
| 2 | --- some statements |
| 3 | myOffSet += getNewOffSet(GlobalParam); |
| 4 | referThis = GlobalParam+myOffSet; |
| 5 | return (*referThis); |

}

In the example function, the return statement may be the cause of an access violation. The return statement may reference to a memory location pointing to a global parameter that has been changed by an outside function. To find a variant of this issue, a human debugger may search manually whenever some operation on a global parameter is performed or try to find the “referThis” global parameter. This search may fail to find the cause of the dereferencing. The potential bug pattern may be the function call and operation sequences. A search of the source code set using the string, “*referThis”, which caused a null reference, may show too many meaningless results. Searching the entire function may give no result or no useful result.

Hence, the bug detection system may identify the code responsible for the bug, in this example statement 5, and do a backward code slice to identify the pattern of this failure and obtain the buggy sequence. The bug detection system may remove any unwanted code lines that are not responsible for the issue. Multiple paths in the source code set may result in multiple patterns, which may be merged to form a unified bug pattern.

Once the bug detection system may identify a bug pattern, the bug detection system may transform the bug pattern into a static format that may be searched through code using any static analysis technique. For example, a code clone detection tool may identify similar patterns elsewhere in the source code set and identify variants of similar security issues automatically.

A clone relation is an equivalence relation between two code fragments that act as if the fragments are the same sequences. Clone code detection may use the relationship between variables to identify cone code instead of the variables themselves. Clone code may occur because the developer reused or copied pre-existing code, changes caused by an enhancement feature, or accidental cloning.

A clone detection system that uses a software pattern derived from a code slice may have applications beyond bug detection, such as finding duplicate code, optimizing code flows, making code more modular, making code more uniform, reducing code footprint, and other software design improvements. Further, such pattern detection techniques may be applied to operating system code, system on a chip code, cloud software code, and other software types.

Thus, in one embodiment, a bug detection system may automatically identify bugs and bug variants in a source code set. The bug detection system may identify automatically a template bug in a source code set. The bug detection system may represent automatically the template bug as a bug pattern. The bug detection system may identify a matching bug in the source code set using the bug pattern.

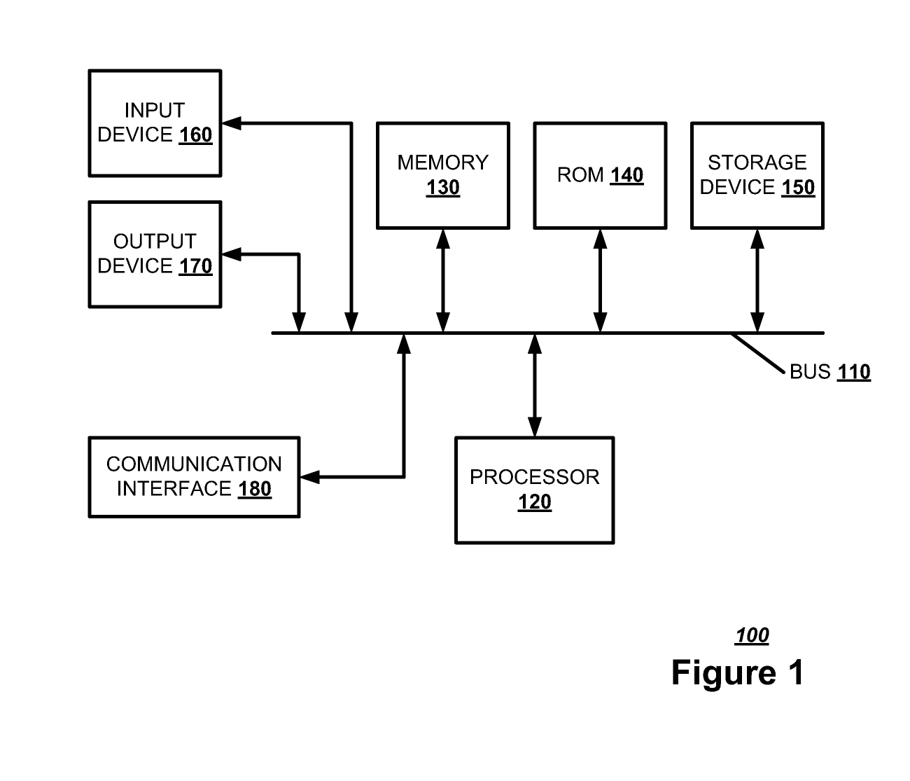

FIG. 1 illustrates a block diagram of an exemplary computing device 100 which may act as a bug detection system. The computing device 100 may combine one or more of hardware, software, firmware, and system-on-a-chip technology to implement bug detection. The computing device 100 may include a bus 110, a processor 120, a memory 130, a read only memory (ROM) 140, a storage device 150, an input device 160, an output device 170, and a communication interface 180. The bus 110 may permit communication among the components of the computing device 100.

The processor 120 may include at least one conventional processor or microprocessor that interprets and executes a set of instructions. The memory 130 may be a random access memory (RAM) or another type of dynamic storage device that stores information and instructions for execution by the processor 120. The memory 130 may also store temporary variables or other intermediate information used during execution of instructions by the processor 120. The memory 130 may store a bug pattern developed from a template bug found in a code slice for the source code set. The ROM 140 may include a conventional ROM device or another type of static storage device that stores static information and instructions for the processor 120. The data storage device 150 may include any type of tangible machine-readable medium, such as, for example, magnetic or optical recording media and its corresponding drive. A tangible machine-readable medium is a physical medium storing machine-readable code or instructions, as opposed to a transitory medium or signal. The storage device 150 may store a set of instructions detailing a method that when executed by one or more processors cause the one or more processors to perform the method. The storage device 150 may also be a database or a database interface for storing source code sets or binary data sets.

The input device 160 may include one or more conventional mechanisms that permit a user to input information to the computing device 100, such as a keyboard, a mouse, a voice recognition device, a microphone, a headset, etc. The output device 170 may include one or more conventional mechanisms that output information to the user, including a display, a printer, one or more speakers, a headset, or a medium, such as a memory, or a magnetic or optical disk and a corresponding disk drive. The communication interface 180 may include any transceiver-like mechanism that enables computing device 100 to communicate with other devices or networks. The communication interface 180 may include a network interface or a transceiver interface. The communication interface 180 may be a wireless, wired, or optical interface.

The computing device 100 may perform such functions in response to processor 120 executing sequences of instructions contained in a computer-readable medium, such as, for example, the memory 130, a magnetic disk, or an optical disk. Such instructions may be read into the memory 130 from another computer-readable medium, such as the storage device 150, or from a separate device via the communication interface 180.

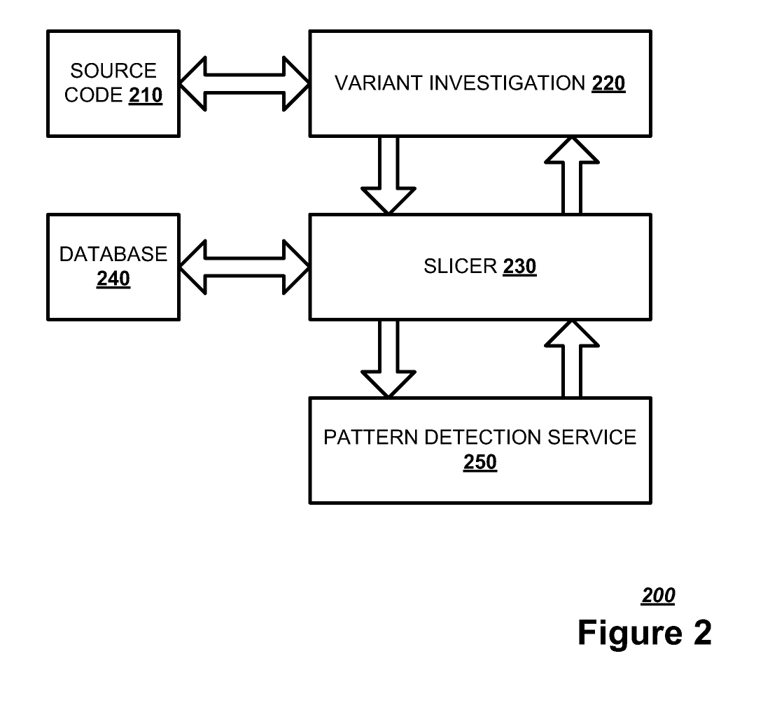

FIG. 2 illustrates, in a block diagram, one embodiment of a bug detection system 200. The bug detection system 200 may import a source code set 210 having bug issues into a variant investigation module 220 for debugging. The variant investigation module 220 may send the source code set 210 to a slicer 230. The slicer 230 may create a code slice from the source code set 210 based on a slicing criterion received from a database 240. The slicer 230 may send a code slice to a pattern detection service 250, such as a clone search service. The pattern detection service 250 may send a pattern detection result set back to the slicer 230 for forwarding to the variant investigation module 220.

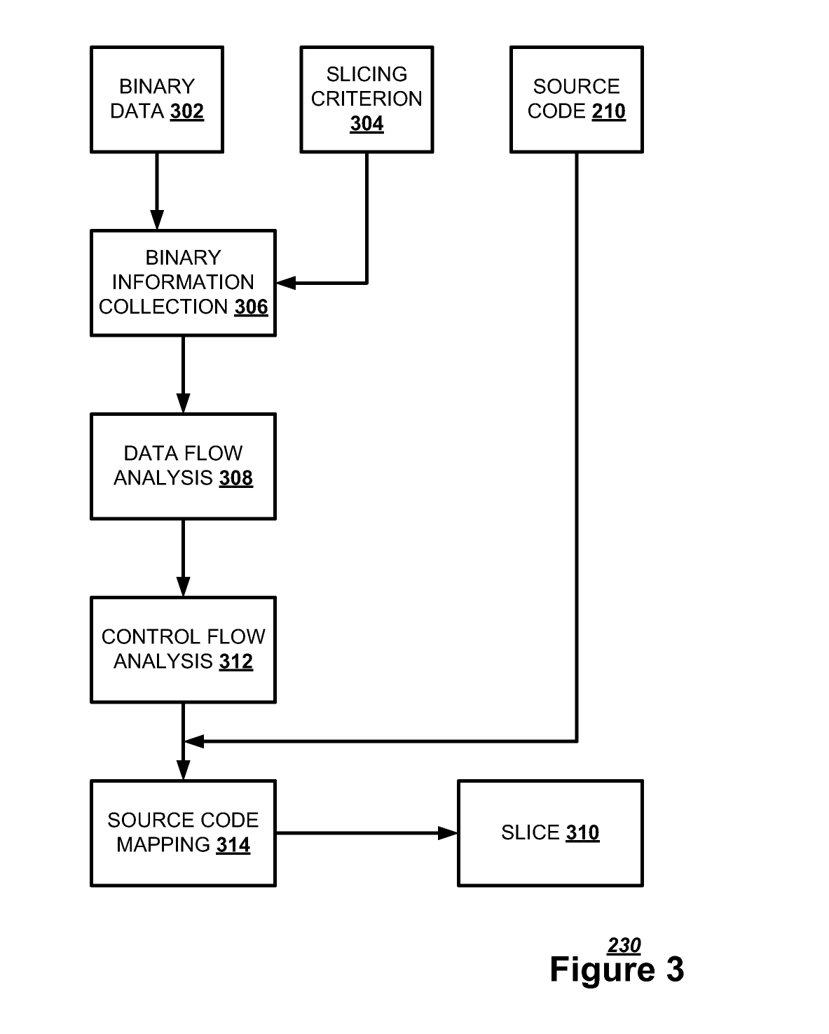

FIG. 3 illustrates, in a block diagram, one embodiment of a slicer 230. The slicer 230 may import a binary data set 302 resulting from the source code data set 210 and a slicing criterion 304 into a binary information collection module 306 for analysis. The binary information module 306 may pass the binary data set 302 and the slicing criterion 304 to a data flow analysis module 308. The data flow analysis module 308 may create directed graphs representing the data flow in the function. A vertex may represent an instruction, with the edge between two vertices represents a data dependency between the two instructions. The data flow analysis module 308 may calculate data dependencies based on the variables and memory addresses an instruction reads from or writes to. Using the instructions in the slicing criterion 304 as a root, the data flow analysis module 308 may traverse the data flow graph to find each vertex till reaching a specified level, or depth, to find the code slice 310. The data flow analysis module 308 may move upward for a backward code slice 310 and downward for a forward code slice 310. The data analysis module may then merge the results for each instruction to form a single code slice 310 to be passed on to the control flow analysis module 312.

The generated code slice 310 may have many different paths that may be followed at runtime during the runtime. Additionally, as some paths may not be feasible, removing such infeasible paths and separating each possible path that may be followed during runtime give the user a better understanding of the flow of the program. Using the control flow information of the procedure, the control flow analysis module 312 may map the generated code slice 310 to the control flow graph. The control flow analysis module 312 may separate each path that may be followed at runtime, with a condition that at least one instruction from the slicing criterion 304 be present in each path. A path may contain instructions in the order of appearance in the control flow graph denoting the order of execution at runtime. The control flow analysis module 312 may map each path to the data flow graph to filter the instructions that fail to use or modify the variables used or defined by the slicing criterion 304 in that path.

A source code mapping module 314 may map the code slices 310 back to the source code set 210. While mapping, the source code mapping module 314 may handle statements written in multiple lines. The source code mapping module 314 may order the code slices 310 as each code slice 310 appears in the source code set 210 or in the control flow graph.

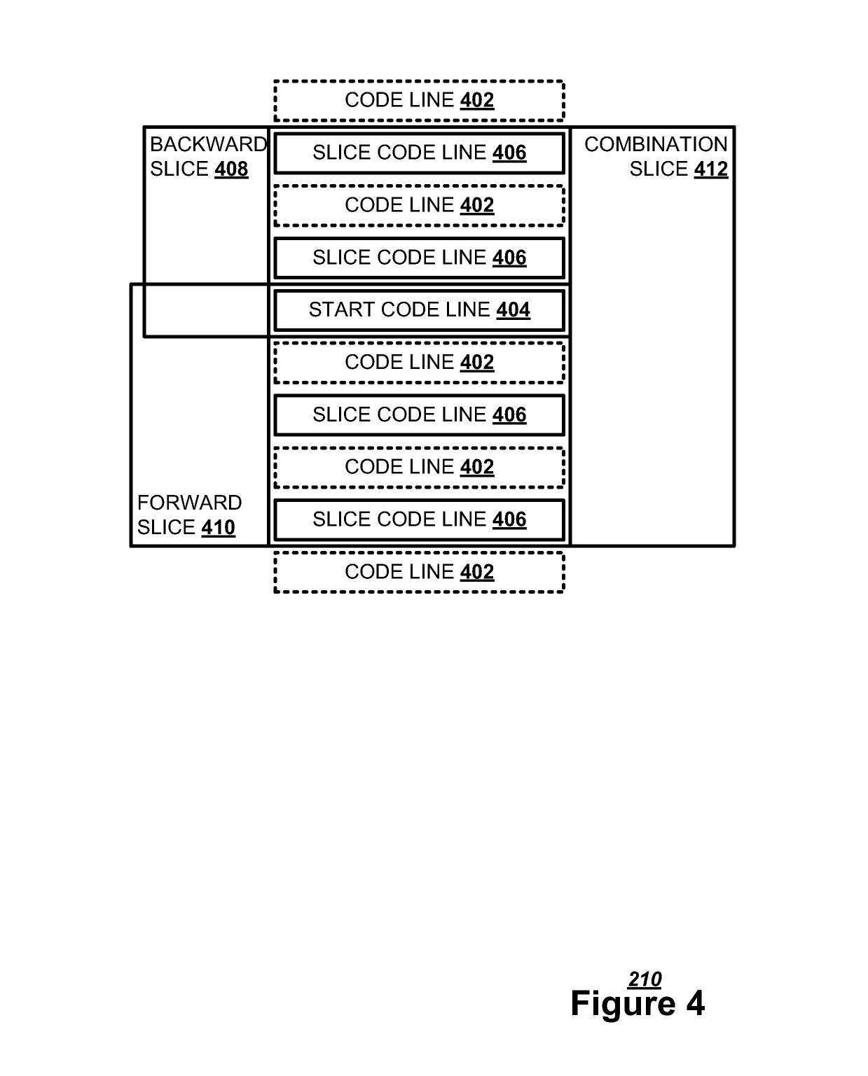

FIG. 4 illustrates, in a block diagram, one embodiment of a source code set 210. A source code set 210 may have multiple code lines 402. A slicer 230 may create a code slice 310 of the source code set 210 beginning at a given start code line 404. The code slice 310 may have a level number of a size optimized to provide a bug pattern. A level number describes the number of slice code lines 406 in the code slice 310. A slice code line 406 is a line that creates or modifies a variable relevant according to the slicing criteria 304. A slicer 230 may omit code lines 402 that do not affect the relevant variable. A backward code slice 408 may provide the level number of slice code lines 406 prior to the start code line 404. A forward code slice 410 may provide the level number of slice code lines 406 after the start code line 404. A combination code slice 412 may provide the level number of slice code lines 406 around the start code line 404.

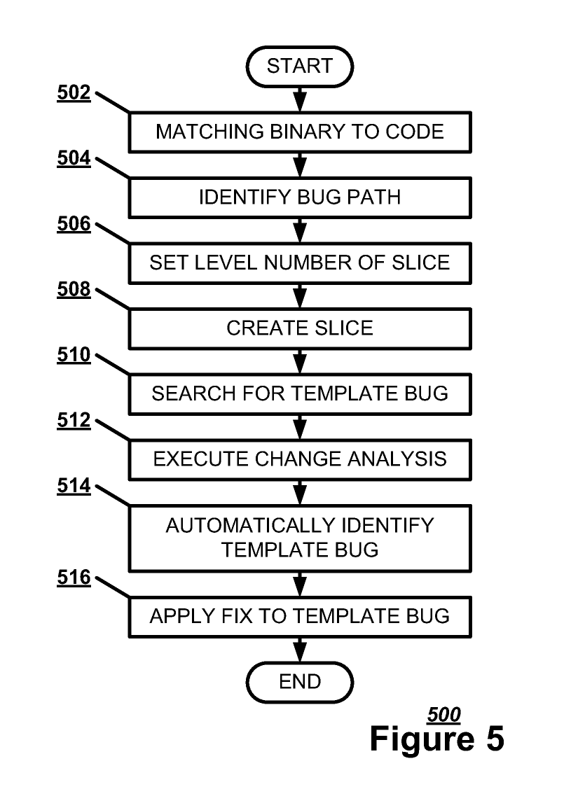

FIG. 5 illustrates, in a flowchart, one embodiment of a method 500 for detecting a template bug. A template bug is the bug that the bug detection system 200 uses as a model to search for other bugs. The template bug may be the initial bug discovered or the optimum bug for search purposes. A bug detection system 200 may match a binary data set 302 to the source code set 210 (Block 502). The bug detection system may identify a bug path in the source code set (Block 504). A bug path is the execution path containing a bug. The bug detection system 200 may set a level number for the code slice 310 to an optimized size (Block 506). The bug detection system 200 may create a code slice 310 of the source code set 210 (Block 508). The bug detection system 200 may search the code slice 310, such as a backward code slice 408, a forward code slice 410, or a combination code slice 412, for a template bug (Block 510). The bug detection system 200 may execute a change analysis on the binary data set 302 (Block 512). The bug detection system 200 may identify automatically a template bug in a source code set (Block 514). The bug detection system 200 may apply a bug fix to the template bug (Block 516).

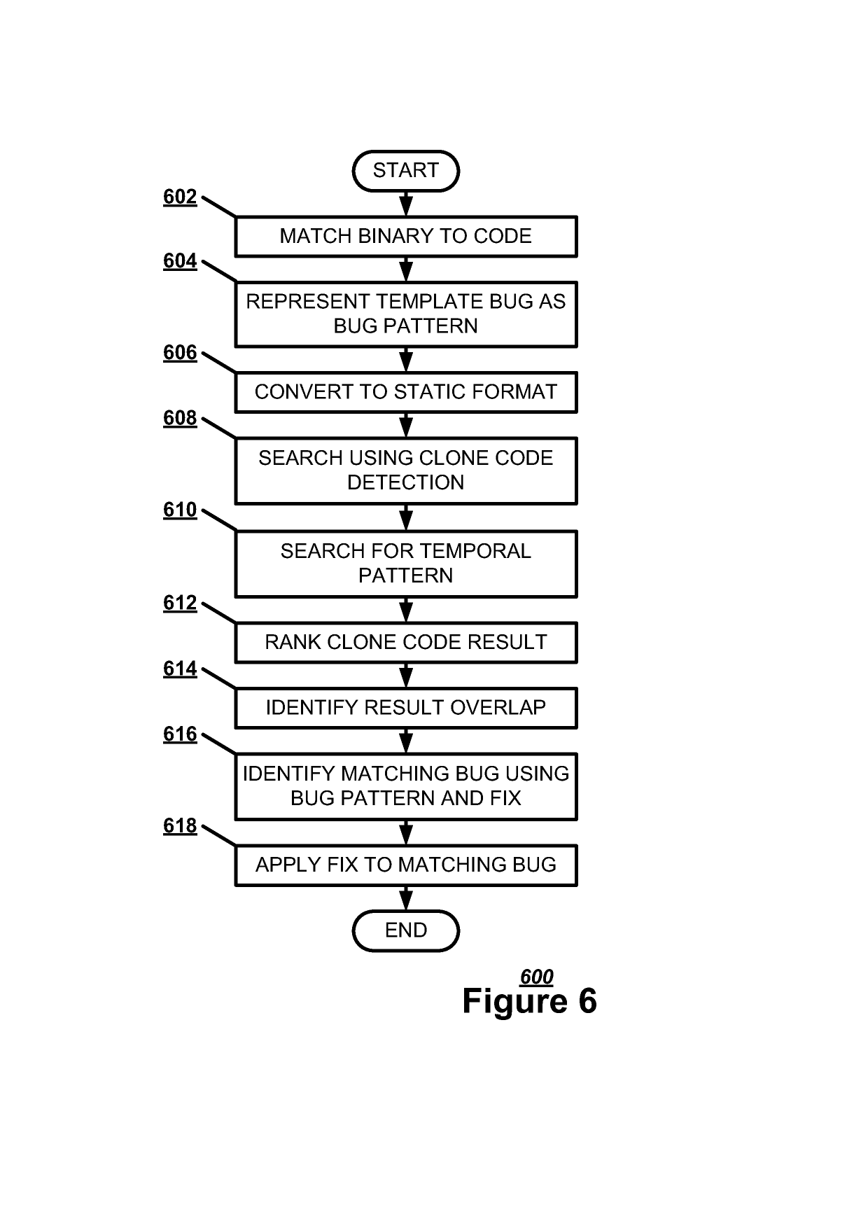

FIG. 6 illustrates, in a flowchart, one embodiment of a method 600 for detecting a matching bug. A matching bug is a bug in the source code set 210 that matches the template bug. A matching bug may differ slightly, but not relevantly, from the template bug. A bug detection system 200 may match a binary data set 302 to the source code set 210 (Block 602). The bug detection system 200 may represent automatically a template bug as a bug pattern (Block 604). The bug detection system 200 may convert the bug pattern to a static format to allow for static analysis, such as model checking, clone detection, and other techniques (Block 606). The bug detection system 200 may search for a bug pattern variant using pattern detection, such as clone code detection (Block 608). The bug detection system 200 may search the source code set 210 for a temporal pattern using the matching binary data set 302 (Block 610). The bug detection system 200 may rank the clone code detection result set (Block 612). The bug detection system 200 may identify any result overlap in a clone code detection result set (Block 614). The bug detection system 200 may identify the matching bug in the source code set using the bug pattern (Block 616). The bug detection system 200 may determine from the bug pattern a bug fix. The bug detection system 200 may identify the matching bug based on an applicability comparison of the bug fix. The bug detection system 200 may apply the bug fix to the matching bug (Block 618).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include non-transitory computer-readable storage media for carrying or having computer-executable instructions or data structures stored thereon. Such non-transitory computer-readable storage media may be any available media that can be accessed by a general purpose or special purpose computer. By way of example, and not limitation, such non-transitory computer-readable storage media can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
identifying automatically a template bug in a source code set;
representing automatically the template bug as a bug pattern; and
identifying a matching bug in the source code set using the bug pattern.

2. The method of claim 1, further comprising:
matching a binary data set to the source code set.

3. The method of claim 2, further comprising:
executing a change analysis on the binary data set.

4. The method of claim 1, further comprising:
creating a code slice of the source code set.

5. The method of claim 4, further comprising:
setting a level number for the code slice to an optimized size.

6. The method of claim 1, further comprising:
searching at least one of a backward code slice, a forward code slice, and a combination code slice for the template bug.

7. The method of claim 1, further comprising:
identifying a bug path in the source code set.

8. The method of claim 1, further comprising:
converting the bug pattern to a static format.

9. The method of claim 1, further comprising:
searching a bug pattern variant using pattern detection.

10. The method of claim 1, further comprising:
searching the source code set for a temporal pattern.

11. The method of claim 1, further comprising:
applying a bug fix to the template bug.

12. The method of claim 11, further comprising:
identifying the matching bug based on an applicability comparison of the bug fix.

13. A tangible machine-readable medium having a set of instructions detailing a method stored thereon that when executed by one or more processors cause the one or more processors to perform the method, the method comprising:
creating a code slice of a source code set;
searching the code slice for a template bug; and
representing automatically the template bug as a bug pattern.

14. The tangible machine-readable medium of claim 13, wherein the method further comprises:
identifying a matching bug in the source code set using the bug pattern.

15. The tangible machine-readable medium of claim 13, wherein the method further comprises:
searching for a bug pattern variant using clone code detection.

16. The tangible machine-readable medium of claim 15, wherein the method further comprises:
ranking a clone code detection result set.

17. The tangible machine-readable medium of claim 15, wherein the method further comprises:
identifying a result overlap in a clone code detection result set.

18. The tangible machine-readable medium of claim 13, wherein the method further comprises:
applying a bug fix to the template bug.

19. A bug detection system, comprising:
a data storage that stores a source code set;
a memory that stores a bug pattern developed from a template bug found in a code slice of the source code set; and
a processor that searches the source code set with the bug pattern using clone code detection for a matching bug.

20. The bug detection system of claim 19, wherein the processor applies a bug fix to the template bug and the matching bug.
